(19) United States
(12) Patent Application Publication
(10) Pub. No.: US 2019/0045762 A1
(43) Pub. Date: Feb. 14, 2019

(54) Lobster Snare Spear-Tip

(71) Applicant: Christopher Luty, St Thomas, VI (US)

(72) Inventor: Christopher Luty, St Thomas, VI (US)

(21) Appl. No.: 15/673,563

(22) Filed: Aug. 10, 2017

(51) Int. Cl. A01K 74/00

(52) U.S. Cl. CPC A01K 74/00

(57) ABSTRACT

A lobster snare spear-tip that can easily be attached to a spearfishing pole-spear shaft or speargun shaft wherein a user can easily switch from a fishing spear-tip to a lobster snare spear-tip. The user can catch both fish and lobster without having to carry both a pole-spear or speargun and a separate full sized-lobster catching device. The Lobster snare spear-tip can be easily carried in a pocket, clipped to their body or diving gear. If the user encounters a lobster while carrying a pole spear or speargun with a fishing spear-tip threaded onto the shaft they can easily switch the fishing spear-tip and replace it with the lobster snare spear-tip. The user can switch back and forth between spear-tips used for fishing and the lobster snare spear-tip as many times as necessary both underwater and on the surface of the water.

### BACKGROUND OF THE INVENTION

This invention relates to snares, in particular a lobster snare spear-tip that can easily be attached to a spearfishing pole-spear shaft or speargun shaft wherein a user can easily switch from a fishing spear-tip to a lobster snare spear-tip. The user can catch both fish and lobster without having to carry both a pole-spear or speargun and a separate full sized-lobster catching device.

Currently, users consisting of snorkelers, free divers and scuba divers and others need to carry a separate full sized-lobster catching device and spearfishing device if they chose to catch fish and catch lobster and it can be cumbersome to carry both devices. By allowing users to switch between a spearfishing spear-tip on their pole-spear or speargun shaft used for fish and replace it with a lobster spear-tip that is carried by the diver they can easily catch both fish and lobster without the burden of carrying two full sized devices.

The Lobster snare spear-tip can be easily carried in a pocket, clipped to their body or diving gear. If the user encounters a lobster while carrying a pole spear or speargun with a fishing spear-tip threaded onto the shaft they can easily switch the fishing spear-tip and replace it with the lobster snare spear-tip. The user can switch back and forth between spear-tips used for fishing and the lobster snare spear-tip as many times as necessary both underwater and on the surface of the water.

### SUMMARY OF THE INVENTION

The primary object of the present invention is to allow a diver to use a lobster snare spear-tip on their pole-spear or speargun shaft.

Another object of the present invention is to allow divers to catch lobster with a snare device and catch fish without having to carry both a separate full sized-lobster snare device and a pole-spear or speargun.

The present invention fulfills the above and other objects by providing a lobster snare spear-tip which allows permits a user to catch lobster using their pole-spear or speargun shaft. A snare comprised of a loop is located on a distal end, which is preferably made of cable and secured to a cylindrical body with internally threaded bore formed in the proximal end. The loop is secured to the cylindrical body by inserting the cable through the distal end exiting the proximal end. A stopper is clamped to the end of the cable larger in diameter than the distal end cable hole and pulled into the cylindrical body where it is locked in place with a threaded stopper screwed into the cylindrical body. The distal end of the cylindrical body is smaller in diameter than the proximal end to allow the lobster snare spear-tip to be as small and compact as possible.

To use the lobster snare spear-tip device, the user attaches the device by threading the lobster snare spear-tip to the user's pole-spear or speargun shaft. The lobster snare spear-tip's loop is placed around the body of the lobster and tightened by pulling the device towards the user.

The above and other objects, features and advantages of the present invention should become even more readily apparent to those skilled in the art upon reading of the following detailed description in conjunction with the drawings wherein there is shown and described illustrative embodiments of the invention.

### BRIEF DESCRIPTION OF THE DRAWINGS

FIG. 1 is an environmental, perspective view from the proximal end of a lobster snare spear-tip used with a pole-spear or spearfishing gun shaft of the present invention;

FIG. 2 is an environmental, perspective view from the distal end of a lobster snare spear-tip used with a pole-spear or spearfishing gun shaft of the present invention;

FIG. 3 is a side view from a proximal perspective of lobster snare spear-tip showing the threaded end of the cylindrical body used for attachment to a pole-spear or speargun shaft of the present invention;

FIG. 4 is a side view from a distal perspective of a lobster snare spear-tip showing the distal end of the cylindrical body where the cable used to form the snare enters of the present invention;

FIG. 5 is a side plan view of a lobster snare spear-tip of the present invention.

### DESCRIPTION OF THE PREFERRED EMBODIMENTS

For the purpose of describing the preferred embodiment, the terminology used in reference to the numbered components in the drawings is as follows:
1. Lobster snare spear-tip
2. Distal End
3. Proximal end
4. Cylindrical body
5. Clamp
6. Cable snare
7. Blind bore
8. Threaded bore
9. Stopper
10. Set screw
11. Set screw detail
12. Though hole for cable
13. Cable hole
14. Slide loop

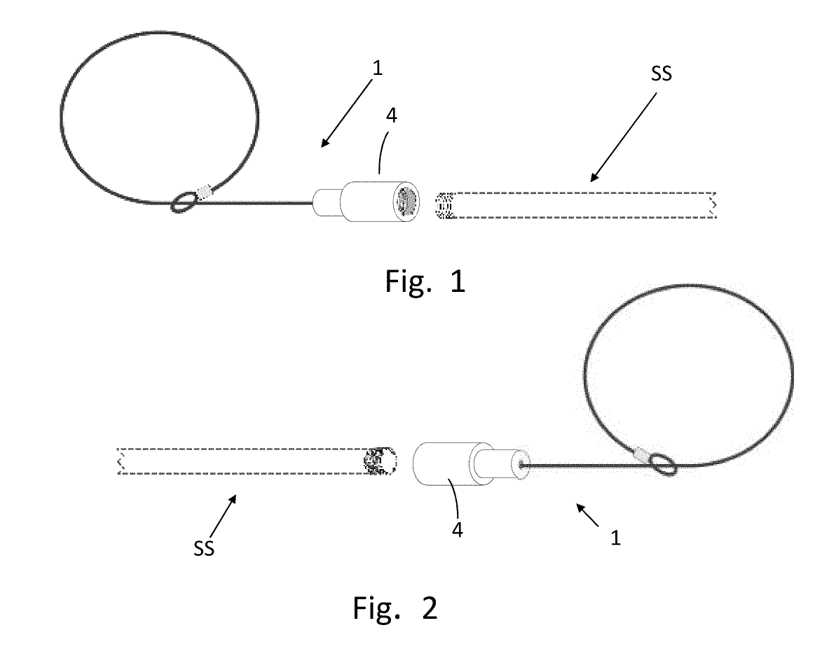

With reference to FIG. 1, an environmental, perspective view from the proximal end of a lobster snare spear-tip 1 of the present invention is shown. The threaded cylindrical body 4 with internally threaded bore can be selectively mounted to one end of a pole-spear shaft SS or a speargun shaft SS.

Referring to FIG. 2, an environmental, perspective view from the distal end of a lobster snare spear-tip 1 of the present invention is shown. The cylindrical body 4 with internally threaded bore can be selectively mounted to one end of a pole-spear shaft or a speargun shaft SS. It is to be understood that the lobster

snare spear-tip 1 is not limited to use with only with spear shafts but can also be attached to other pole-type and spear-like devices.

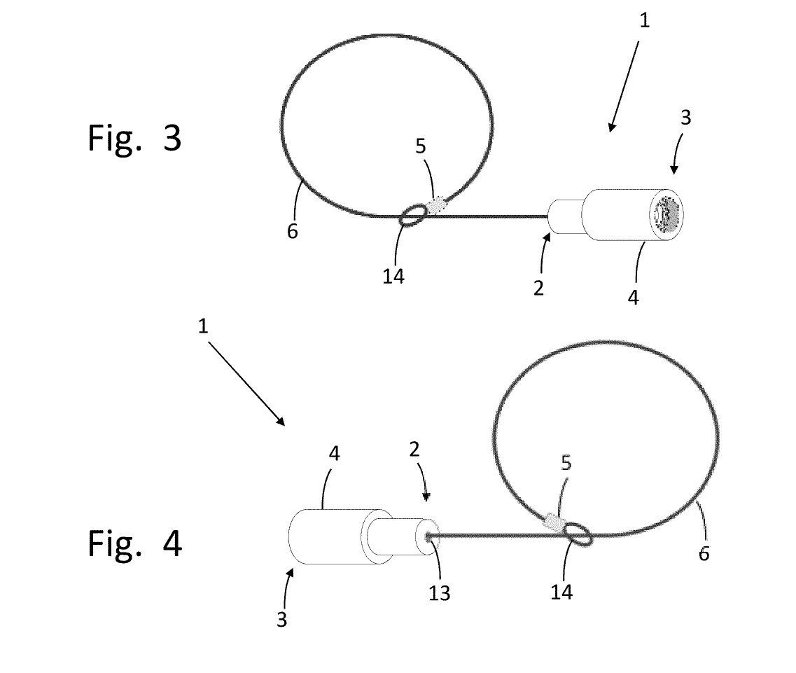

Referring to FIG. 3, a side view with a proximal perspective of a lobster snare spear-tip 1 with a cable snare 6 consisting of a cable loop constructed with wire or metal cable entering the distal end 2 of the cylindrical body 4 through a cable hole 13. A slide loop 14 is formed using a clamp 5 or other means such as welding to create a loop.

Referring to FIG. 4, a side view with a distal perspective of a lobster snare spear-tip 1 with a cable snare 6 consisting of a cable loop constructed with wire or metal cable entering the distal end 2 of the cylindrical body 4 through a cable hole 13. A slide loop 14 is formed using a clamp 5 or other means such as welding to create a loop.

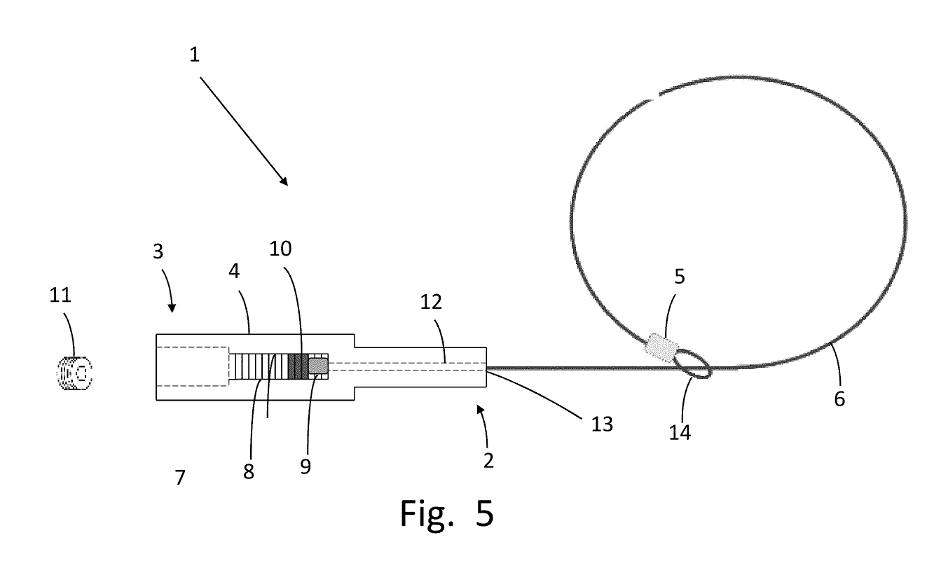

Referring to FIG. 5, a side plan view of a lobster snare spear-tip 1 with a cable snare 6 consisting of a cable loop constructed with wire or metal cable entering the distal end 2 of the cylindrical body 4 entering through a cable hole 13. A slide loop 14 is formed using a clamp 5 or other means such as welding to create a loop. The cable of the cable snare 6 passes all the way through the cylindrical body by entering through the through hole for cable 12 which goes from the distal end 2 through the proximal end 3. The cable end is secured in the cylindrical body 4 via a stopper 9 attached to the end of the cable which is wedged against the smaller diameter through hole for cable 12 by means of a set screw 10 into the cylindrical body by passing it through the blind bore 7 and threading it into the threaded bore 8. Set screw detail 11 of the set screw 10 is presented.

It is to be understood that the present invention is not limited to the embodiments described above, but encompasses any and all embodiments within the scope of the following claims.

What is claimed is:

1. A lobster snare spear-tip comprising:
a cylindrical body with a proximal end and distal end with smaller distal end diameter;
a blind bore in said cylindrical body on the proximal end;
a threaded bore within said cylindrical body beginning at the end of the said blind bore of said cylindrical body;
a through hole goes through the said cylindrical body from the distal end to the proximal end;
a cable attached internally of said cylindrical body by means of a stopper attached to said cable and secured with a threaded set screw and exiting the distal end of said cylindrical body;
a loop is created using said cable by creating a smaller loop surrounding the said cable and secured with a clamp;

2. The lobster snare spear-tip of claim 1 wherein:
said cable enters the distal end of said cylindrical body through said through hole;
said cable is attached internally of said cylindrical body by means of a stopper attached to said cable end and pressed against the smaller said through hole with a set screw threaded into said threaded bore within said cylindrical body;
said loop is created using said cable by creating a smaller loop surrounding the said cable and secured with a clamp;

3. The lobster snare spear-tip of claim 1 wherein:
said cylindrical body has a blind bore at the proximal end.

4. The lobster snare spear-tip of claim 1 wherein:
said cylindrical body has a threaded bore beginning at the end of said blind bore.

5. The lobster snare spear-tip of claim 1 wherein:
said through hole for cable goes through said cylindrical body from the distal to proximal end.

6. The lobster snare spear-tip of claim 2 wherein:
said loop is created by creating a said smaller loop surround the cable with said clamp.

7. The lobster snare spear-tip of claim 1 wherein:
said cable is a wire.

8. The lobster snare spear-tip of claim 1 wherein:
said cable is a rope.

9. The lobster snare spear-tip of claim 1 wherein:
said set screw is a threaded hex screw.
